(19) United States
(12) Patent Application Publication
(10) Pub. No.: US 2015/0364090 A1
(43) Pub. Date: Dec. 17, 2015

(54) ORGANIC LIGHT EMITTING DISPLAY AND METHOD OF DRIVING THE SAME

(71) Applicant: SAMSUNG DISPLAY CO., LTD., Yongin-City (KR)

(72) Inventors: Kwang-Hae Kim, Yongin-City (KR); Min-Young Kim, Yongin-City (KR); Young-Joo Lee, Yongin-City (KR); In-Young Jung, Yongin-City (KR)

(21) Appl. No.: 14/740,138

(22) Filed: Jun. 15, 2015

(30) Foreign Application Priority Data
Jun. 16, 2014 (KR) 10-2014-0072829

(51) Int. Cl. G09G 3/32

(52) U.S. Cl. CPC G09G 3/3266; G09G 2320/0233; G09G 2300/0819; G09G 2300/0814; G09G 2310/0283

(57) ABSTRACT

An organic light emitting display includes pixels located at a region defined by scan lines and data lines, i blocks, each of the i blocks including two or more scan lines wherein i is a natural number that is 2 or greater, a control driver configured to supply a first control signal to i first control lines and a second control signal to i second control lines, each of the first and second control lines being in a corresponding one of the blocks, a scan driver configured to supply a scan signal to the scan lines and a data driver configured to supply a data signal to the data lines, wherein the scan driver is configured to supply the scan signals to the scan lines in different directions in adjacent ones of the blocks.

### CROSS-REFERENCE TO RELATED APPLICATION

The present application claims priority to and the benefit of Korean Patent Application No. 10-2014-0072829, filed on Jun. 16, 2014, in the Korean Intellectual Property Office, the entire contents of which are incorporated herein by reference.

### BACKGROUND

1. Field

Embodiments of the present invention relate to an organic light emitting display and a method for driving the same.

2. Description of the Related Art

With recent developments of information technology, the importance of display devices, acting as a medium for connecting information and users, has increased. Use of flat panel displays (FPD) such as liquid crystal displays (LCD), organic light emitting diode displays, plasma display panels (PDP), etc. is also on the rise.

Organic light emitting displays, among FPDs, display images using organic light emitting diodes (OLEDs) which generate light by electron-hole recombination. The advantages of organic light emitting displays include fast response times and low power consumption.

### SUMMARY

The present invention may have purposes other than those specifically described herein, as a person of ordinary skill in the art would readily appreciate.

Aspects of embodiments of the present invention provide an organic light emitting display and a method for driving the same, capable of or suitable for enhancing image quality.

In an embodiment, an organic light emitting display may include pixels located at a region defined by scan lines and data lines, i blocks, each of the i blocks including two or more scan lines, wherein i is a natural number that is 2 or greater, a control driver configured to supply first control signals to i first control lines and second control signals to i second control lines, each of the first and second control lines being in a corresponding one of the blocks, a scan driver configured to supply scan signals to the scan lines and a data driver configured to supply data signals to the data lines, wherein the scan driver is configured to supply the scan signals to the scan lines in different directions in adjacent ones of the blocks.

In an embodiment, the scan driver may be configured to supply scan signals in a first direction from a j-th block from among the i blocks and may supply scan signals in a second direction that is different from the first direction from a (j+1)-th block from among the i blocks, wherein j is a natural number.

In an embodiment, the first direction may be a direction going from the top to the bottom of one of the blocks, and the second direction may be a direction from the bottom to the top of one of the blocks.

In an embodiment, scan signals may be concurrently supplied on a block-by-block basis, and the supply of scan signals may be sequentially interrupted.

In an embodiment, the supply of scan signals on the block-by-block basis may be interrupted in the sequence of the first direction or the second direction.

In an embodiment, the control driver may sequentially supply first control signals to the i first control lines and sequentially supply second control signals to the i second control lines such that the second control signals overlap the first control signals for some time.

In an embodiment, the scan signal may have a voltage at which a transistor in the pixels is turned on, and the first control signals and the second control signals may have voltages at which the transistor included in the pixels is turned off.

In an embodiment, the first control signal supplied to the j-th block may be supplied after the scan signals are concurrently supplied to the scan lines included in the j-th block, the second control signal supplied to the j-th block may be supplied after the first control signal is supplied, and the supply of the second control signal may be interrupted after the supply of the first control signal is interrupted.

In an embodiment, the scan driver may be configured to sequentially interrupt supply of the scan signals supplied to the scan lines in the j-th block during the period when the first and second control signals supplied to the j-th block overlap each other.

The data driver may be configured to supply the data signals to the data lines during the period when the first control signals overlap the second control signals and may supply a reference power which has (e.g., is set to) a specific voltage to the data lines during a remaining period.

In an embodiment, at least one of the pixels may include an organic light emitting diode, a first transistor configured to control a current that is supplied to the organic light emitting diode from a first power source coupled to a first electrode of the first transistor, in response to a voltage applied to a first node, a second transistor coupled between the first node and a corresponding one of the data lines, and configured to be turned on when the scan signals are supplied, a third transistor coupled between the first electrode of the first transistor and the first power source, the third transistor being configured to be turned off when the first control signals are supplied and to be turned on in other cases, a fourth transistor coupled between a second electrode of the first transistor and an anode electrode of the organic light emitting diode, the fourth transistor configured to be turned off when the second control signals are supplied and to be turned on in other cases, a fifth transistor coupled between the anode electrode of the organic light emitting diode and an initialization power source and configured to be turned on when the scan signals are supplied, and a first capacitor and a second capacitor coupled in series between the first node and the first power source, wherein a second node, which is a common terminal of the first and second capacitors, is electrically coupled to the first electrode of the first transistor.

In an embodiment, a method for driving an organic light emitting display including i blocks each including a plurality of pixels, wherein i is a natural number that is 2 or greater, the method including concurrently compensating for threshold voltages of driving transistors in the pixels on a block-by-block basis, supplying scan signals on the block-by-block basis and storing voltages corresponding to data signals in the pixels, and emitting light from the pixels on the block-by-block basis, wherein a scanning sequence of the scan signals may be in different directions in adjacent ones of the blocks.

In an embodiment, scan signals may be supplied in a first direction from a j-th block from among the blocks and in a second direction that is different from the first direction from a (j+1)-th block from among the blocks, wherein j is a natural number.

In an embodiment, the first direction may be a direction from the top to the bottom of one of the blocks, and the second direction may be a direction from the bottom to the top of one of the blocks.

In an embodiment, the scan signals may be concurrently supplied on the block-by-block basis and supply of the scan signals may be sequentially interrupted.

In an embodiment, the supply of the scan signals on the block-by-block basis may be interrupted in a sequence of the first direction or the second direction.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout. Further, when a first element is referred to as being coupled or connected to a second element, the first element may be directly coupled or connected to the second element or may be indirectly coupled or connected to the second element through one or more intervening elements.

FIG. 1 illustrates an organic light emitting display according to an embodiment of the present invention.

FIG. 2 illustrates a pixel according to an embodiment.

FIG. 3 is a waveform diagram illustrating a driving method according to a first embodiment.

FIG. 4A illustrates a change in a voltage of a data line according to the driving waveform shown in FIG. 3.

FIG. 4B schematically illustrates the luminance of a boundary part of a block according to the driving waveform shown in FIG. 3.

FIG. 5 is a waveform diagram illustrating a driving method according to a second embodiment.

FIG. 6 schematically illustrates the luminance of a boundary part between blocks as carried out in accordance with the driving method shown in FIG. 5.

### DETAILED DESCRIPTION

Hereinafter, reference will now be made in detail to embodiments, examples of which are illustrated in the accompanying drawings. As used herein, the term “and/or” includes any and all combinations of one or more of the associated listed items.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section, without departing from the spirit and scope of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Expressions such as “at least one of,” when preceding a list of elements, modify the entire list of elements and do not modify the individual elements of the list. Further, the use of “may” when describing embodiments of the inventive concept refers to “one or more embodiments of the inventive concept.”

When a first element is described as being “coupled” or “connected” to a second element, the first element may be directly “coupled” or “connected” to the second element, or one or more other intervening elements may be located between the first element and the second element.

It will be understood by one of ordinary skill in the art that expressions such as “corresponding to,” “corresponds to,” etc. may be used herein to describe when one element or feature is based on, according to, determined by, or controlled by another element of feature.

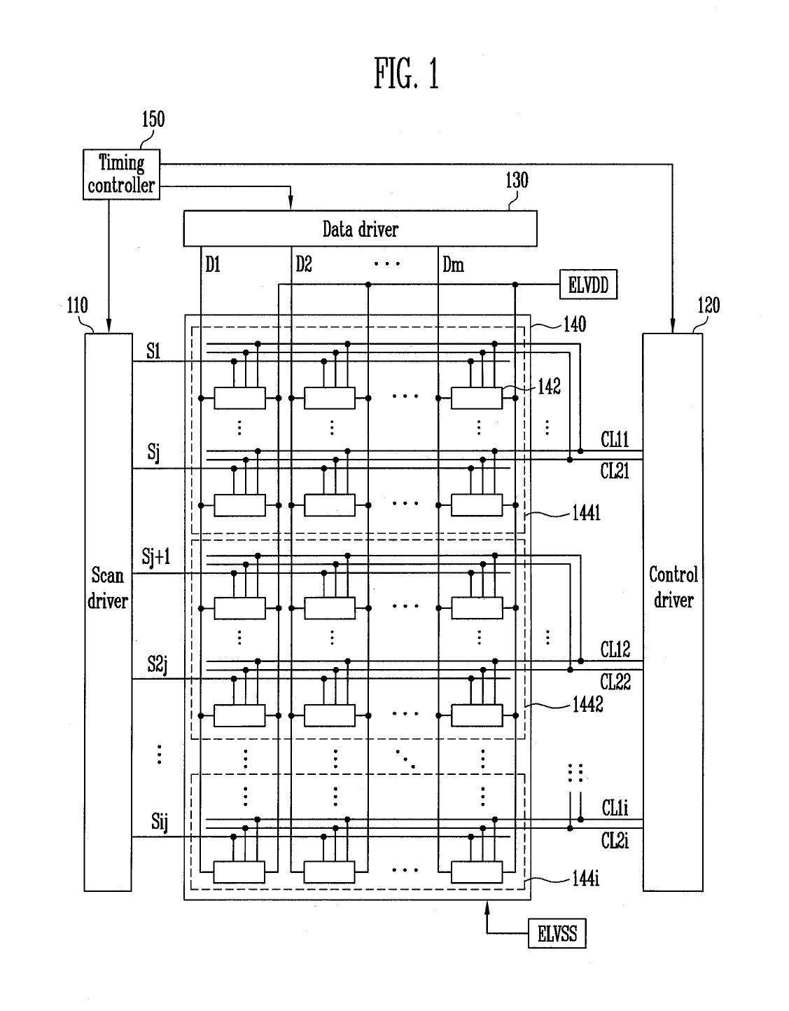

FIG. 1 illustrates an organic light emitting display according to an embodiment of the present invention.

Referring to FIG. 1, the organic light emitting display may include a pixel unit (or pixel region or pixel area) 140 having pixels 142 located at regions partitioned by scan lines S1 to Sij and data lines D1 to Dm, i blocks 1441 to 144i (where i is a natural number that is 2 or greater) including (e.g., divided to include) two or more scan lines, a scan driver 110 configured to drive the scan lines S1 to Sij, a control driver 120 configured to drive first control lines CL11 to CL1i and second control lines CL21 to CL2i formed in each block, a data driver 130 configured to drive the data lines D1 to Dm and a timing controller 150 configured to control the drivers 110, 120 and 130.

The pixel unit 140 may be divided into the i blocks 1441 to 144i. Each of the blocks 1441 to 144i may include a plurality of pixels 142. Those pixels 142 that are located in a same block may concurrently compensate for a threshold voltage of a driving transistor. When the threshold voltage of the driving transistor is compensated on the block-by-block basis (1441 to 144i), the time for compensating the threshold voltage may be sufficiently allocated. As a result, threshold voltage of the driving transistor may be compensated in a stable manner.

A control line (any one of CL11 to CL1i) and a second control line (any one of CL21 to CL2i) may be formed in each of the blocks (any one of 1441 to 144i). In the pixel unit 140, there may be provided i first control lines CL11 to CL1i and i second control lines CL21 to CL2i. A k-th first control line CL1k and a k-th second control line CL2k formed in a k-th block (where k is a natural number) may be coupled in common to the pixels 142 that are located at the k-th block.

The control driver 120 may sequentially supply first control signals to the first control lines CL11 to CL1i and sequentially supply second control signals to the second control lines CL21 to CL2i. The second control signal supplied to the k-th second control line CL2k may be supplied after the first control signal is supplied to the k-th first control line CL1k. The supply of the second control signal may be interrupted after the supply of the first control signal has been interrupted. The first and second control signals may have (e.g., be set to) a voltage (e.g., a high voltage) at which a transistor included in the pixels 142 is turned off.

The scan driver 110 may supply scan signals to the scan lines S1 to Sij. The scan driver 110 may supply the scan signals on a block-by-block basis. The scan driver 110 may concurrently supply the scan signals to the scan lines located at a k-th block 144k before the first control signal is supplied to the k-th first control line CL1k. The scan driver 110 may maintain a supply of scan signals to the scan lines located at the k-th block 144k until the first control signal of the k-th first control line CL1k overlaps the second control signal of the k-th second control line CL2k. Subsequently, the scan driver 110 may sequentially interrupt the supply of the scan signals supplied to the scan lines located at the k-th block 144k during the period when the first and second control signals are overlapped and charge the pixels 142 with a voltage corresponding to a desired data signal.

The scan driver 110 may supply the scan signals in a direction that is different from an adjacent block. For example, the scan driver 110 may interrupt the supply of scan signals in a first direction from a j-th block (where j is an odd or even number) and may interrupt the supply of scan signals in a second direction that is different from the first direction from a j+1th block. The first direction may refer to a direction from the top to the bottom of the block, and the second direction may refer to a direction from the bottom to the top of the block. The description relating to the sequence in which the scan signals are supplied from the scan driver 110 will be described below. The scan signal may have (e.g., be set to) a voltage (e.g., a low voltage) at which the transistor included in the pixels 142 may be turned on.

Although the scan driver 110 and the control driver 120 are shown as separate drivers in FIG. 1, the present invention is not limited thereto. For example, the scan driver 110 and the control driver 120 may be formed as one driver.

The data driver 130 may supply data signals to the data lines D1 to Dm corresponding to the supply of the scan signals, which are sequentially interrupted. The data signal may be supplied to the pixels 142 selected by the scan signal. The data driver 130 may supply the voltage of a reference power to the data lines D1 to Dm during at least some of a period when no data signal is supplied. The reference power may have (e.g., be set to) a voltage (e.g., a specific voltage) within the voltage range of the data signal.

The pixels 142 may be located at regions partitioned by the scan lines S1 to Sij and the data lines D1 to Dm. Such pixels 142 may generate light having a luminance (e.g., a predetermined luminance) while controlling the amount of a current that flows from a first power source ELVDD to a second power source ELVSS via an OLED in response to the data signal.

The timing controller 150 may control the scan driver 110, the control driver 120 and the data driver 130.

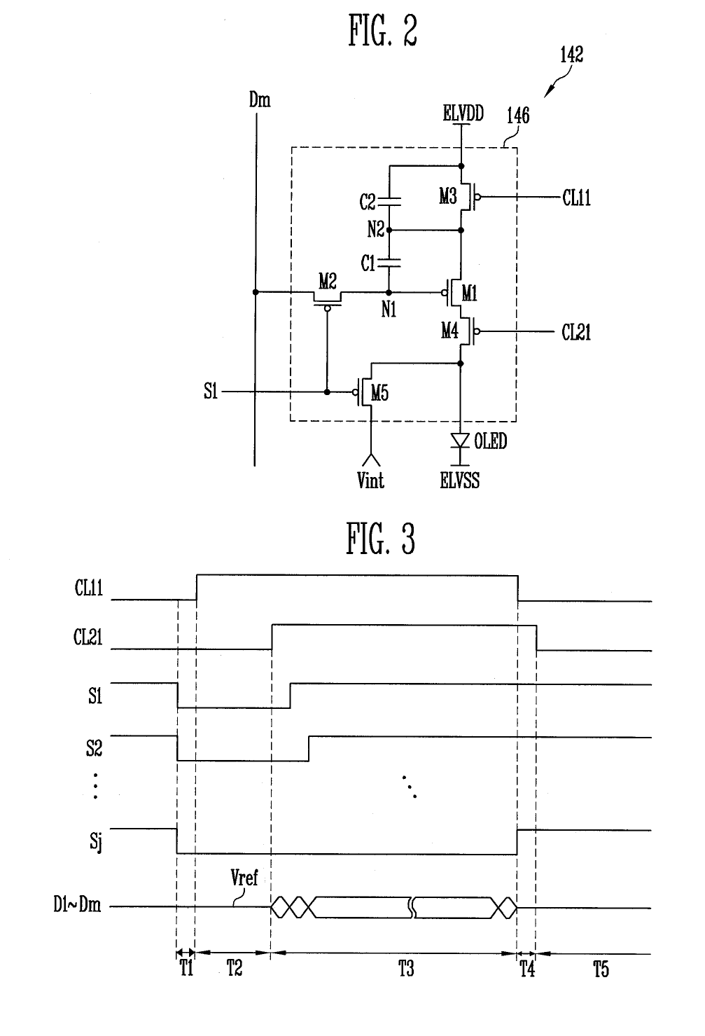

FIG. 2 illustrates a pixel according to an embodiment. For convenience, FIG. 2 shows the pixel coupled to the m-th data line Dm and the first scan line S1.

Referring to FIG. 2, the pixel 142 according to embodiments of the present invention may include the OLED and a pixel circuit 146 configured to control the amount of the current supplied to the OLED.

An anode electrode of the OLED may be coupled to the pixel circuit 146, and a cathode electrode thereof may be coupled to the second power source ELVSS. The OLED may generate light having a luminance (e.g., a predetermined luminance) depending on the amount of the current supplied from the pixel circuit 146. In order to allow current to flow in the OLED, the second power source ELVSS may have (e.g., be set to) a voltage that is lower than that of the first power source ELVDD.

The pixel circuit 146 may control the amount of the current that is supplied to the OLED in response to the data signal. To this end, the pixel circuit 146 may include first to fifth transistors M1 to M5, a first capacitor C1 and a second capacitor C2.

A first electrode of the first transistor M1 (i.e., a driving transistor) may be coupled to the first power source ELVDD via the third transistor M3. A second electrode thereof may be coupled to the anode electrode of the OLED via the fourth transistor M4. A gate electrode of the first transistor M1 may be coupled to a first node N1. The first transistor M1 may control the amount of the current that flows from the first power source ELVDD to the second power source ELVSS via the OLED depending on the voltage applied to the first node N1.

A first electrode of the second transistor M2 may be coupled to the data line Dm, and the second electrode thereof may be coupled to the first node N1. A gate electrode of the second transistor M2 may be coupled to the scan line S1. The second transistor M2 may be turned on when the scan signal is supplied to the scan line S1 to electrically couple the data line Dm to the first node N1.

A first electrode of the third transistor M3 may be coupled to the first power source ELVDD, and the second electrode thereof may be coupled to the first electrode of the first transistor M1. A gate electrode of the third transistor M3 may be coupled to the first control line CL11. The third transistor M3 may be turned off when the first control signal is supplied to the first control line CL11 and turned on in other cases.

A first electrode of the fourth transistor M4 may be coupled to the second electrode of the first transistor M1, and the second electrode of the fourth transistor M4 may be coupled to the anode electrode of the OLED. A gate electrode of the fourth transistor M4 may be coupled to the second control line CL21. The fourth transistor M4 may be turned off when the second control signal is supplied to the second control line CL21 and turned on in other cases.

A first electrode of the fifth transistor M5 may be coupled to the anode electrode of the OLED, and a second electrode thereof may be coupled to an initialization power source Vint. A gate electrode of the fifth transistor M5 may be coupled to the scan line S1. The fifth transistor M5 may be turned on when the scan signal is supplied to the scan line S1 to supply the voltage of the initialization power source Vint to the anode electrode of the OLED. The initialization power source Vint may have (e.g., be set to) a voltage (e.g., a low voltage) at which the OLED may be turned off.

The first capacitor C1 and the second capacitor C2 may be coupled in series between the first node N1 and the first power ELVDD. A second node N2 that is a common terminal of the first capacitor C1 and the second capacitor C2 may be electrically coupled to the first electrode of the first transistor M1. The first capacitor C1 and the second capacitor C2 may store a voltage corresponding to the threshold voltage of the first transistor M1 and the data signal.

FIG. 3 is a waveform diagram illustrating a driving method according to a first embodiment. For convenience, FIG. 3 shows the driving waveform supplied to the first block 1441.

Referring to FIG. 3, the first control signal may be supplied to the first control line CL11 located at the first block 1441 during a second period T2 and a third period T3, and the second control signal may be supplied to the second control line CL21 during the third period T3 and a fourth period T4. And reference power Vref may be supplied to the data lines D1 to Dm during the first period T1 and the second period T2.

During the first period T1, the scan signal may be concurrently supplied to the scan lines S1 to Sj. When the scan signal is supplied to the scan lines S1 to Sj, the second transistor M2 and the fifth transistor M5 of each of the pixels 142 located at the first block 1441 may be turned on. When the fifth transistor M5 is turned on, the voltage of the initialization power source Vint may be supplied to the anode electrode of the OLED. Then, the OLED may be initialized by discharging an organic capacitor (not shown) which is parasitically formed at the OLED.

When the second transistor M2 is turned on, the data line (any one of D1 to Dm) may be electrically coupled to the first node N1. When the data line (any one of D1 to Dm) and the first node N1 are electrically coupled to each other, the voltage of the reference power Vref may be supplied to the first node N1. Because the ref power Vref has (e.g., is set to) a voltage (e.g., a specific voltage) within the data signal (e.g., excluding a grayscale voltage for black), the first transistor M1 may be turned on (e.g., set to be turned on). A current (e.g., a predetermined current) may flow from the first power source ELVDD to the initialization power source Vint via the first transistor M1, the fourth transistor M4 and the fifth transistor M5.

The first transistor M1 may display an image having uniform luminance because the first transistor M1 may be set to a turn-on state, i.e., an on-bias state, during the first period T1. That is, the voltage characteristics of the first transistor M1 included in each of the pixels 142 may be non-uniform (e.g., set to be non-uniform) in response to a grayscale of a previous period. The first transistor M1 of each of the pixels 142 included in the first block 1441 may be initialized to be in the on-bias state during the first period T1, and the voltage characteristics may be uniform (e.g., set to be uniform). Since the current flowing via the first transistor M1 during the first period T1 may be supplied to the initialization power source Vint, the OLED may maintain a non-emitting state.

The first control signal may be supplied to the first control line CL11 during the second period T2. When the first control signal is supplied to the first control line CL11, the third transistor M3 of each of the pixels 142 included in the first block 1441 may be turned off. When the third transistor M3 is turned off, the first power source ELVDD may be electrically disconnected from the second node N2. In this case, the first node N1 may maintain the voltage of the reference power Vref.

Therefore, during the second period T2, a current (e.g., a predetermined current) may flow from the second node N2 to the initialization power source Vint via the first transistor M1, the fourth transistor M4 and the fifth transistor M5. The voltage of the second node N2 may be decreased from the voltage of the first power source ELVDD to a voltage that is the sum of the reference power Vref and the absolute value of the threshold voltage of the first transistor M1. When the voltage of the second node N2 is a voltage (e.g., set to a voltage) that is the sum of the reference power Vref and the absolute value of the threshold voltage of the first transistor M1, the first transistor M1 may be turned off. Then, the first capacitor C1 may be charged with the voltage corresponding to the threshold voltage of the first transistor M1.

The threshold voltage of the first transistor M1 that is included in each of the pixels 142 of the first block 1441 may be compensated during the second period T2. The threshold voltage of the first transistor M1 included in each of the pixels 142 may be compensated on a block-by-block basis. As such, sufficient time may be allocated during the second period T2 to compensate threshold voltage in a stable manner.

During the third period T3, the supply of the scan signals supplied to the scan lines S1 to Sj may be sequentially interrupted. For example, the supply of the scan signals may be sequentially interrupted, in the sequence from the first scan line S1 to the j-th scan line Sj. In addition, during the third period T3, the second control signal may be supplied to the second control line CL21 so that the fourth transistor M4 included in each of the pixels 142 of the first block 1441 may be turned off. When the fourth transistor M4 is turned off, the first transistor M1 may be electrically blocked from the OLED.

During a period when the scan signals are supplied to the scan lines S1 to Sj, the second transistor M2 and the fifth transistor M5 included in each of the pixels 142 of the first block 1441 may be kept turned on. The data signal corresponding to the pixel 142 coupled to the first scan line S1 i.e., the data signal corresponding to a first horizontal line, may be supplied to the data line D1 to Dm.

The data signals supplied to the data lines D1 to Dm may be supplied to the first node N1 of each of the pixels 142 located at the first to j-th horizontal lines. When the data signal is supplied to the first node N1, the voltage of the first node N1 may be changed from the voltage of the reference power Vref to the voltage of the data signal. In this case, the voltage of the second node N2 may also change in response to the change in voltage of the first node N1. For example, the voltage of the second node N2 may change to a voltage (e.g., a predetermined voltage) in response to the capacitance ratio of the first capacitor C1 and the second capacitor C2. Then, the first capacitor C1 may be charged with the voltage corresponding to the threshold voltage of the first transistor M1 and the data signal.

After the first capacitor C1 of each of the pixels 142 included in the first block 1441 is charged with the voltage of the data signal corresponding to the first horizontal line, the supply of the scan signal to the first scan line S1 may be interrupted. When the supply of the scan signal to the first scan line S1 is interrupted, each of the pixels 142 located at the first horizontal line may maintain the voltage stored in the first capacitor C1.

Thereafter, the data driver 130 may supply the data signal corresponding to the second horizontal line to the data lines D1 to Dm. Then, the voltage of the data signal corresponding to the second horizontal line may be stored in the first capacitor C1 of each of the pixels 142 located at the second to j-th horizontal lines. After the voltage of the data signal corresponding to the second horizontal line is stored in the first capacitor C1, the supply of the scan signal to the second scan line S2 may be interrupted. Each of the pixels 142 located at the second horizontal line may maintain the voltage stored in the first capacitor C1. Similarly, the pixels 142 located at the third to the j-th horizontal lines may repeat the above-mentioned process, and thus store a voltage corresponding to a desired data signal.

During the fourth period T4, the supply of the first control signal to the first control line CL1 may be interrupted, and the third transistor M3 may be turned on. When the third transistor M3 is turned on, the second node of each of the pixels 142 of the first block 1441 may be electrically coupled to the first power source ELVDD. Since the first node N1 may be set to a floating state, the first capacitor C1 may maintain the voltage charged during the previous period in a stable manner.

During the fifth period T5, the supply of the second control signal to the second control line CL21 may be interrupted, and the fourth transistor M4 may be turned on. When the fourth transistor M4 is turned on, the first transistor M1 may be electrically coupled to the anode electrode of the OLED. Then, the first transistor M1 may control the amount of the current supplied to the OLED depending on the voltage stored in the first capacitor C1.

In practice, the pixels 142 included in the first block 1441 may generate light having a luminance (e.g., a predetermined luminance) in response to the data signal while repeating the above-described process. During the fifth period T5, when the pixels of the first block 1441 emit light, the first control signal and the second control signal may be supplied to the first control line CL12 and the second control line CL22 which are coupled to the second block 1442, so that the pixels 142 included in the second block 1442 may generate light having a luminance (e.g., a predetermined luminance) while repeating the above-described process. Likewise, the pixels 142 included in the third to i-th blocks 144i may be driven through the above-mentioned process.

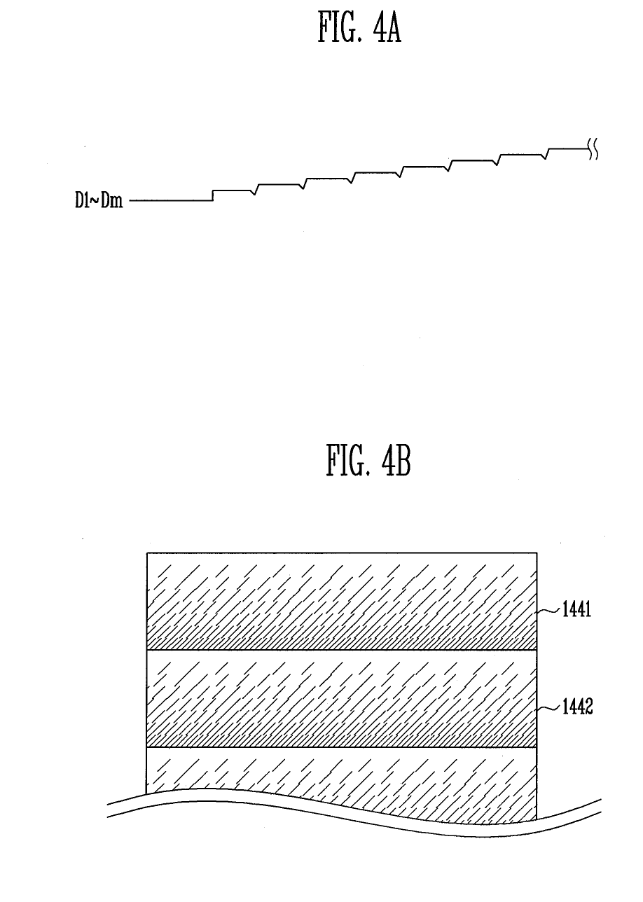

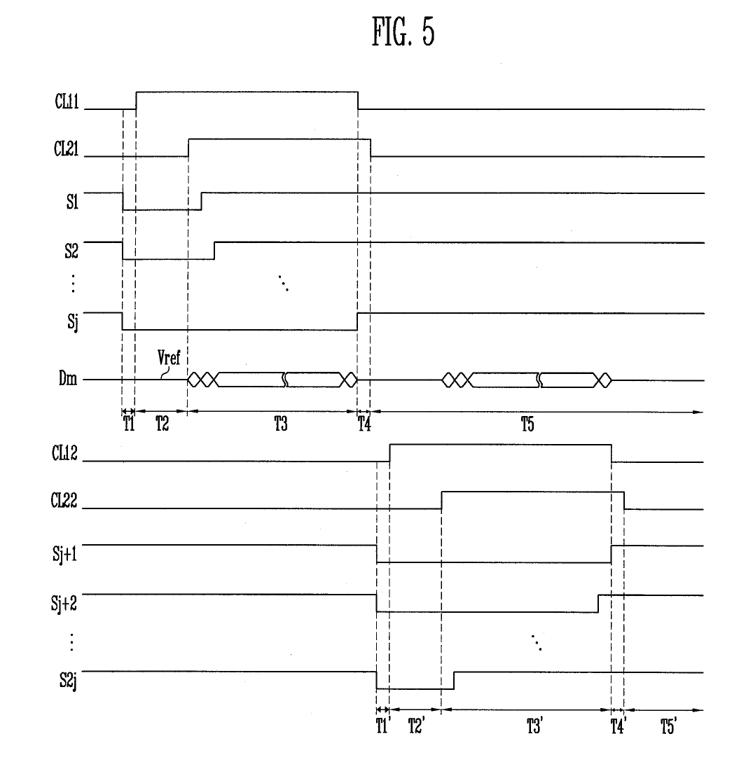

When the pixels 142 are driven by the driving method according to the first embodiment, the boundary parts of the blocks 1441 to 144i may appear as horizontal lines. In other words, when the supply of the scan signal is sequentially interrupted, the voltage of the data lines D1 to Dm may increase due to the parasitic capacitor between the scan line S and the data line D, the parasitic capacitor between the gate electrode of the second transistor M2 included in each of the pixels 142 and the first electrode, etc. For example, when the supply of the scan signals to the scan lines is sequentially interrupted, the voltage of the data lines D1 to Dm may increase as shown in FIG. 4A. Therefore, even if the same data signal (e.g., substantially the same data signal) is supplied to the pixels 142, the luminance may decrease in a direction from the top to the bottom of the block as shown in FIG. 4B. As a result, the boundary parts of the blocks 1441 to 144i may appear as horizontal lines.

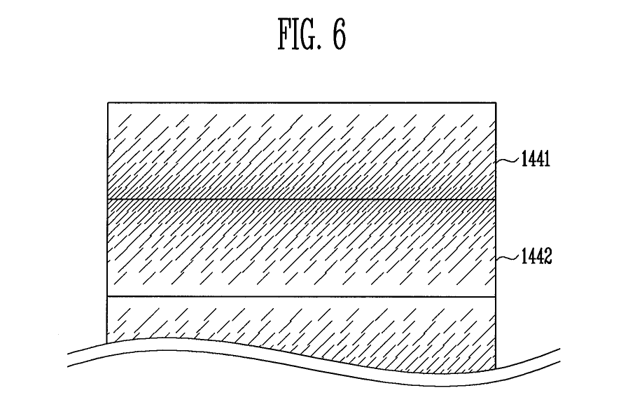

FIG. 5 is a waveform diagram illustrating a driving method according to a second embodiment. The operation process during a first period T1′ through a fifth period T5′ shown in FIG. 5 is substantially the same as FIG. 3. Repeated descriptions will be omitted.

Referring to FIG. 5, the sequence of supplying the scan signal may be different at an adjacent block according to a second embodiment. In other words, the supply of the scan signal in the first direction may be interrupted at the j-th block, and the supply of the scan signal in the second direction may be interrupted at the (j+1)-th block. The data driver 130 may supply the data signal to the data lines D1 to Dm such that the direction in which the data signal is supplied corresponds to the first direction from the j-th block. The data signal may be supplied to the data lines D1 to Dm such that the direction in which the data signal is supplied corresponds to the second direction from the (j+1)-th block. For example, the data driver 130 may supply the data signals corresponding to the first to j-th horizontal lines in response to the first block 1441, and supply the data signals corresponding to the 2j to (j+1)-th horizontal lines in response to the second block 1442.

When the supply of the scan signal in the first direction from the j-th block is interrupted, the luminance may decrease at the lower part of the j-th block. When the supply of the scan signal in the second direction from the (j+1)-th block is interrupted, the luminance may decrease at the upper part of the (j+1)-th block. In this case, since the luminance of the boundary part of the j-th block and the (j+1)-th block becomes similar, the boundary part may not be readily observable by the user.

By establishing the sequence of the supply of the scan signal in a reversed direction at the j-th block and the (j+1)-th block (i.e., the sequence of interrupting the supply of the scan signal), the luminance of the boundary part of the block may be similar (e.g., set to be similar) as shown in FIG. 6. In the second embodiment, the driving method according to the second embodiment remains the same as the driving method shown in FIG. 3, except for the supply sequence of the scan signal between adjacent blocks. Therefore, the detailed description of the driving method according to the second embodiment will be omitted.

For the convenience of description, the transistors are illustrated as PMOS, but the present invention is not limited thereto. In other words, the transistors may be formed as NMOS.

Furthermore, the OLED may generate red, green, blue or white light depending on a current. When the OLED generates the white light, it is possible to implement a color image using an additional color filter.

By way of summation and review, the organic light emitting display may include a plurality of pixels that are arranged in a matrix form at intersections (or crossing regions) of data lines, scan lines, and power lines. The pixels generally include an OLED, two or more transistors including a driving transistor, and one or more capacitors.

Such an organic light emitting display's power consumption is low, but the current flowing in the OLED is changed depending on a deviation of the threshold voltage of the driving transistor included in each of the pixels, thus causing a non-uniform display. That is, the characteristics of the driving transistors are changed depending on manufacture process variables of the driving transistor provided at each of the pixels. It is difficult to manufacture the organic light emitting display such that all the transistors thereof have the same characteristics. This causes the deviation of the threshold voltages of the driving transistors.

In order to overcome the problems, there has been proposed a method in which a compensation circuit having a plurality of transistors and capacitors is added to each of the pixels. The compensation circuit included in each of the pixels performs the charging of a voltage that corresponds to the threshold voltage of the driving transistor during one horizontal period, thus compensating for the deviation of the driving transistor.

Recently, in order to implement a motion blur and/or 3D display, a driving method using the driving frequency of 120 Hz or more is used. However, in the case of performing the high-speed driving of 120 Hz or more, the period of charging the threshold voltage of the driving transistor is shortened, so that it is very difficult to compensate for the threshold voltage of the driving transistor.

In the organic light emitting display and the driving method thereof according to embodiments of the present invention, the threshold voltage of the driving transistors is compensated for on the block-by-block basis which includes the plurality of pixels, and a sufficient amount of time for compensating for the threshold voltage may be allocated. Also, by setting the sequence of supply of the scan signal differently in adjacent blocks, boundary parts between blocks may be prevented (e.g., substantially prevented) from being readily observable.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims, and their equivalents.

What is claimed is:

1. An organic light emitting display comprising:
pixels located at a region defined by scan lines and data lines;
i blocks, each of the i blocks comprising two or more scan lines, wherein i is a natural number that is 2 or greater;
a control driver configured to supply first control signals to i first control lines and second control signals to i second control lines, each of the first and second control lines being in a corresponding one of the blocks;
a scan driver configured to supply scan signals to the scan lines; and
a data driver configured to supply data signals to the data lines,
wherein the scan driver is configured to supply the scan signals to the scan lines in different directions in adjacent ones of the blocks.

2. The organic light emitting display of claim 1, wherein the scan driver is configured to supply scan signals in a first direction from a j-th block from among the i blocks and to supply scan signals in a second direction that is different from the first direction from a (j+1)-th block from among the i blocks, wherein j is a natural number.

3. The organic light emitting display of claim 2, wherein the first direction is a direction from a top to a bottom of one of the blocks, and the second direction is a direction from the bottom to the top of one of the blocks.

4. The organic light emitting display of claim 2, wherein the scan signals are concurrently supplied on a block-by-block basis and supply of the scan signals is sequentially interrupted.

5. The organic light emitting display of claim 4, wherein the supply of the scan signals on the block-by-block basis is interrupted in a sequence of the first direction or the second direction.

6. The organic light emitting display of claim 2, wherein the control driver is configured to sequentially supply the first control signals to the i first control lines and the second control signals to the i second control lines in such a way as to overlap the first control signals during a period.

7. The organic light emitting display of claim 6, wherein the scan signals have a voltage at which a transistor in the pixels is turned on, and the first control signals and the second control signals have voltages at which the transistor in the pixels is turned off.

8. The organic light emitting display of claim 6,
wherein the first control signal supplied to the j-th block is supplied after the scan signals are concurrently supplied to the scan lines in the j-th block,
wherein the second control signal supplied to the j-th block is supplied after the first control signal is supplied, and
wherein the supply of the second control signal is interrupted after the supply of the first control signal is interrupted.

9. The organic light emitting display of claim 8, wherein the scan driver is configured to sequentially interrupt supply of the scan signals supplied to the scan lines in the j-th block during the period when the first and second control signals supplied to the j-th block overlap each other.

10. The organic light emitting display of claim 8, wherein the data driver is configured to supply the data signals to the data lines during the period when the first control signals overlap the second control signals, and to supply a reference power having a specific voltage to the data lines during a remaining period.

11. The organic light emitting display of claim 1, wherein at least one of the pixels comprises:
an organic light emitting diode;
a first transistor configured to control a current that is supplied to the organic light emitting diode from a first power source coupled to a first electrode of the first transistor, in response to a voltage applied to a first node;
a second transistor coupled between the first node and a corresponding one of the data lines, and configured to be turned on when the scan signals are supplied;
a third transistor coupled between the first electrode of the first transistor and the first power source, the third transistor being configured to be turned off when the first control signals are supplied and to be turned on in other cases;
a fourth transistor coupled between a second electrode of the first transistor and an anode electrode of the organic light emitting diode, the fourth transistor configured to be turned off when the second control signals are supplied and to be turned on in other cases;
a fifth transistor coupled between the anode electrode of the organic light emitting diode and an initialization power source, and configured to be turned on when the scan signals are supplied; and
a first capacitor and a second capacitor coupled in series between the first node and the first power source,
wherein a second node, which is a common terminal of the first and second capacitors, is electrically coupled to the first electrode of the first transistor.

12. A method of driving an organic light emitting display comprising i blocks each comprising a plurality of pixels, wherein i is a natural number that is 2 or greater, the method comprising:
concurrently compensating for threshold voltages of driving transistors in the pixels on a block-by-block basis;
supplying scan signals on the block-by-block basis and storing voltages corresponding to data signals in the pixels; and
emitting light from the pixels on the block-by-block basis,
wherein a scanning sequence of the scan signals is in different directions in adjacent ones of the blocks.

13. The method of claim 12, wherein the scan signals are supplied in a first direction from a j-th block from among the blocks and in a second direction that is different from the first direction from a (j+1)-th block from among the blocks, wherein j is a natural number.

14. The method of claim 13, wherein the first direction is a direction from a top to a bottom of one of the blocks, and the second direction is a direction from the bottom to the top of one of the blocks.

15. The method of claim 13, wherein the scan signals are concurrently supplied on the block-by-block basis and supply of the scan signals is sequentially interrupted.

16. The method of claim 15, wherein the supply of the scan signals on the block-by-block basis is interrupted in a sequence of the first direction or the second direction.
